(19) United States
(12) Patent Application Publication
(10) Pub. No.: US 2013/0205133 A1
(43) Pub. Date: Aug. 8, 2013

(54) STRONGLY AUTHENTICATED, THIRD-PARTY, OUT-OF-BAND TRANSACTIONAL AUTHORIZATION SYSTEM

(71) Applicant: David K. Hess, Dallas, TX (US)

(72) Inventor: David K. Hess, Dallas, TX (US)

(21) Appl. No.: 13/761,900

(22) Filed: Feb. 7, 2013

Related U.S. Application Data
(60) Provisional application No. 61/596,137, filed on Feb. 7, 2012.
(60) Provisional application No. 61/596,147, filed on Feb. 7, 2012.

(51) Int. Cl. H04L 29/06

(52) U.S. Cl. CPC H04L 63/0884
USPC 713/155

(57) ABSTRACT

A system and method to perform an out-of-band authenticated authorization of an activity. A requesting system initiates an authorization request for an activity which is signed using a key pair managed by a transaction server. The authorization request is asymmetrically encrypted for the intended authorizing system and is communicated to the server and stored. The authorizing system receives notification of the request and communicates with the transaction server to retrieve the request, decrypt it and verify the signature. The authorizing system interprets the request and generates an authorization response which is signed and encrypted such that only the requesting system can decrypt it. The response is communicated back to the transaction server which notifies the requesting system. The requesting system communicates with the server to retrieve the response, decrypt it, verify the signature and interpret the response to take action on the activity that initiated the request.

### CROSS-REFERENCE TO RELATED APPLICATIONS

This application claims priority benefit from U.S. Provisional Patent Application No. 61/596,137, filed on Feb. 7, 2012 and U.S. Provisional Patent Application No. 61/596,147 filed on Feb. 7, 2012.

### FIELD OF THE INVENTION

This invention relates to a system and method for securely transmitting a transactional authorization request between two parties in a secure and strongly authenticated manner over a dedicated, out-of-band network utilizing digital certificates, digital encryption and digital signatures in such a way that the parties are not exposed to the usage of digital certificates and the system cannot see the contents of nor tamper with the requests.

### BACKGROUND OF THE INVENTION

Authorization is a relatively simple concept: the function of formally approving something. It takes many forms: in-person verbal approvals, electronic signatures, release forms, receipts and other document signatures, telephone approvals, presenting an ID, entering a PIN code, entering a code provided by SMS, etc. It also covers many subjects: financial transactions, parental consent, credit card transactions, medical procedures, corporate approvals, buyer sign-off, etc. Authorization is prevalent and necessary to maintain an orderly society.

Authorizations have two qualities that lend to their veracity: the authentication of the parties involved and the irrefutability of the authorization itself.

Many existing forms of authorization are weak in their abilities to accurately identify the parties and to create an irrefutable authorization. For example, people can be impersonated and credentials can be forged. PIN codes and passwords can be stolen and people conducting an authorization are subject to social engineering. People can lie about their actions and bribe involved personnel.

An ideal authorization process would both strongly authenticate the requesting and authorizing parties (preventing forgery) and create irrefutable evidence of authorization (preventing refutation). Privacy is also a desirable property as authorizations typically cover sensitive activities and contain personal information.

In recent years, computing devices and the Internet have become pervasive. Desktop computers, mobile devices and servers interconnect with Local Area Networks (LANs) which interconnect with Wide Area Networks (WANs) which ultimately interconnect with the Internet. The Internet is composed of various carriers whose networks interconnect in a way that results in “peer-to-peer” communications. Any computing device can theoretically communicate directly with any other device (looking at connectivity only and ignoring the issue of firewalls and other mechanisms of security policy).

This advance has allowed society to move more activities “online”—many of which require authorization. To enable this, many authentication mechanisms and techniques have been developed: passwords, PIN codes, one-time passwords, biometrics, tokens, etc. These techniques are normally categorized into factors: “something you know”, “something you have” and “something you are”. Systems with higher security needs employ “multi-factor” authentication—the combination of multiple factors into a single authentication event.

As in-person authorization forms have been supplanted by electronic authorization enabled by these new authentication techniques, new risks have emerged; malware can steal passwords, mobile malware can intercept SMS messages, mobile devices with pre-authorized software can be stolen, secret keys for tokens can be stolen, etc. The result is that these new authentication techniques have not substantially improved the authentication and irrefutability properties of the involved authorizations.

Two particular forms of electronic authorization are prevalent on the Internet: website sign-in and remote terminal consoles. Website sign-in involves a user operating a web browser and accessing the website of an organization (service provider) that is managing some set of resources on the behalf of the user. In order to ensure that users do not access the wrong resources, a website requires a user to present credentials: typically a username and password. While this is commonly recognized as an authentication step, it is more accurately viewed as an authorization request for what follows: the establishment of a session in which the user operates the web browser to access and manipulate the resources associated with the presented credentials.

Remote terminal consoles typically involve the software tool “ssh”. Ssh allows a user to initiate a remote terminal session on another computer over the Internet. In the most common case, a session is established by authenticating with username and password. Again, it is more accurate to view this authentication as nothing more than a by-product of an authorization request to establish the login session which follows.

Most electronic authorization systems, especially website sign-in and remote terminal consoles, share the characteristic of being “in-band”—the authentication step is occurring on the same communication channel as the session or other authorized activity which follows it. In each case, the communication channel is combined with the session. Website sign-ins have a web browser and use TCP/IP over the Internet optionally protected by SSL. Ssh has a dedicated application and uses TCP/IP over the Internet.

Though in-band authentication has been the defacto standard for decades, there are serious problems with it: the management of credentials and the “attack surface” that results.

Credentials usually consist of a username and password. They are established between a user and each service provider they have a relationship with. The weakness of this approach is the many-to-many exponential growth that comes with scaling. Users must manage and protect a large number of credentials while service providers must build authentication mechanisms and safely store the means to authenticate presented credentials.

The result is widespread security weaknesses. Each user is susceptible to malware attacks that can steal their passwords, compromised communication channels that steal their passwords, social engineering attacks that convince them to reveal their passwords, etc. Each service provider is susceptible to bug exploitation, credential database compromise, social engineering, etc. Together, these two sets of weaknesses represent an exponentially large “attack surface” that miscreants can and do take advantage of.

Websites are starting to address these concerns by supporting “third-party” authentication. While still in-band, it is separating out the concerns of authentication from authorization. When a user attempts to sign-in to a website, they are provided an option to use the authentication result of that user authenticating with a third-party website to substitute for authentication on the current website. In other words, the current website is willing to take evidence of authentication with a third-party website as sufficient for establishing a session. While this is a step in the right direction, it still suffers from being in-band and tends to involve third-party websites which many users would prefer not be involved in third-party authentication due to privacy concerns.

The security of this new environment of pervasive computing and authentication techniques relies heavily on encryption technology. “Encryption” involves mathematical algorithms which renders information opaque to anyone that does not possess the proper “key” to “decrypt” it. There are two primary families of encryption technology: symmetric and asymmetric encryption.

When using symmetric encryption, the encryptor (Alice) and decryptor (Bob) use the same key to both encrypt and decrypt information. If the Alice wishes to protect information being transmitted to Bob, she must not only encrypt and transmit the information but must also securely transmit the key to Bob. Key distribution can be problematic and is commonly referred to as the “key distribution” problem.

Asymmetric encryption involves the use of key-pairs. Each pair involves a public key and a private key that are related in a mathematical fashion. Information encrypted with the public key can only be decrypted with the private key. Due to this relationship, the public key does not need to be kept secret—only the private requires protection. As a result, asymmetric encryption does not suffer from the key distribution problem. The unique properties of asymmetric encryption also naturally enable operations such as digital signatures and properties such as non-repudiation.

Asymmetric encryption has very desirable properties and operations when considering the weaknesses in existing electronic authorizations systems. The public keys are easier to distribute; encryption (privacy) is therefore easier to achieve. Private keys can be used to perform signatures; irrefutability is therefore easier to achieve.

What asymmetric encryption suffers from is cost and complexity. In order to effectively use asymmetric encryption in a broad setting, a Public Key Infrastructure (PKI) must be established. A PKI involves a root key-pair and corresponding signing certificate. Issuing new key-pairs involves requests and root signing of public keys resulting in certificates. Certificates are easy to distribute but must be validated to assure they are properly issued. Certificate revocation requires live queries to the certificate store or the management of certificate revocation lists. This complexity results in high costs and users are typically unable to conceptualize and manage these issues. As a result, PM tends to only be deployed in situations where cost is not a primary concern or the security requirements are sufficient to demand it.

### SUMMARY OF INVENTION

Disclosed is a method and system that addresses the authentication and irrefutability weaknesses of many forms of authorization, both electronic and non-electronic. The invention also uniquely takes advantage of the pervasiveness of mobile computing devices and Internet access to perform authorizations out-of-band. An out-of-band authorization system leverages the current trend towards third-party authentication, protects against in-band security weaknesses and shrinks the attack surface by eliminating the credential relationship between a user and a service provider. A PKI is transparently employed to achieve strong authentication, irrefutability and privacy without exposing the complexity of a PKI to the users of the system. The result is remarkable in that the system is able to provide a dedicated, third-party, out-of-band authorization transaction service while simultaneously having no visibility into the content of any individual transaction.

### BRIEF DESCRIPTION OF THE DRAWINGS

In the detailed description of the preferred embodiments presented below, reference is made to the accompanying drawings.

FIG. 1 is a block diagram of a preferred embodiment of an authorization transaction system.

FIG. 2 is a system flow diagram of a preferred embodiment of an authorization process.

FIG. 3 is a block diagram of an embodiment of an authorization transaction system deployed in a networked environment.

FIG. 4 is a system flow diagram of a registration process for registering a native device with an authorization transaction system in accordance with the present disclosure.

FIG. 5 is a system flow diagram of a website registration process for registering a website server with an authorization transaction system in accordance with the present disclosure.

FIG. 6 is a block diagram of an embodiment of an out-of-band authorization transaction system for a website sign-in.

FIGS. 7A, 7B and 7C depict a system flow diagram of an out-of-band authorization transaction for a website sign-in in accordance with the present disclosure.

FIG. 8 is a block diagram of an embodiment of an out-of-band authorization transaction system for a credit card transaction.

FIGS. 9A, 9B and 9C depict a system flow diagram of an out-of-band authorization transaction for a credit card transaction in accordance with the present disclosure.

FIG. 10 is a block diagram of an embodiment of an authorization transaction system for website authorization and sign-in from a native authorization application.

FIGS. 11A, 11B and 11C depict a system flow diagram of an authorization transaction for a website authorization and sign-in from a native authorization application in accordance with the present disclosure.

### DETAILED DESCRIPTION OF THE PREFERRED EMBODIMENT

Reference will now be made in detail to the present embodiments of the present invention, examples of which are illustrated in the accompanying drawings, wherein like reference numerals refer to the like elements throughout. The embodiments are described below to explain the present invention by referring to the figures.

As is well known to those skilled in the art, computers, servers, laptops and mobile devices (collectively, “computing devices”) consist of processors operating stored program operating environments, user input and display interfaces and network connections. A set of stored programs (“applications”), when executed by the processors, provide users with Internet functionality, for instance, to access websites, to establish remote terminal sessions on another device, to send and receive text messages, make phone calls, to watch videos, etc. In the case of a computer server, such as web server and a transaction authorization server, the applications, when executed by the processors of the server, establish the terminal sessions with the computing devices and carry out methods to service authorization requests made by those devices.

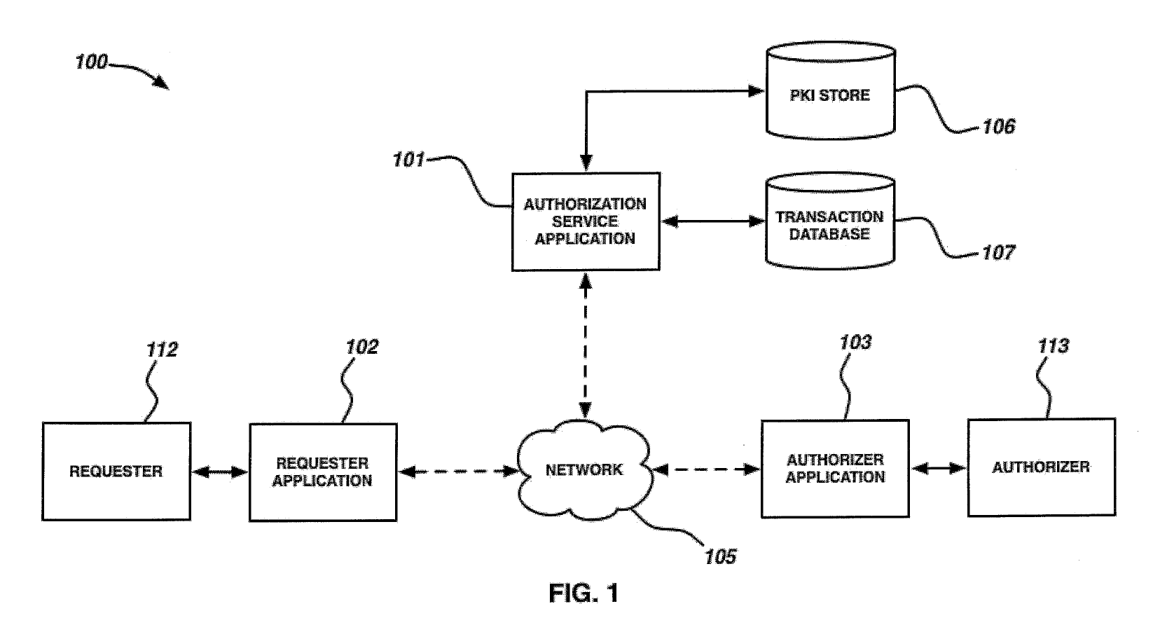

A preferred embodiment is shown in FIG. 1. An authorization transaction system 100 comprises a set of applications including an authorization service application 101, a requester application 102 and an authorizer application 103. The set of applications are communicatively connected through a network 105. Authorization transaction system 100 further comprises a PKI store 106 and a transaction database 107. A requester 112 is in communications with requester application 102. Requester 112 is an entity requiring authorization to provide a service to a client. An authorizer 113 is in communications with authorizer application 103. Authorizer 113 is an entity supplying authorization credentials for the service.

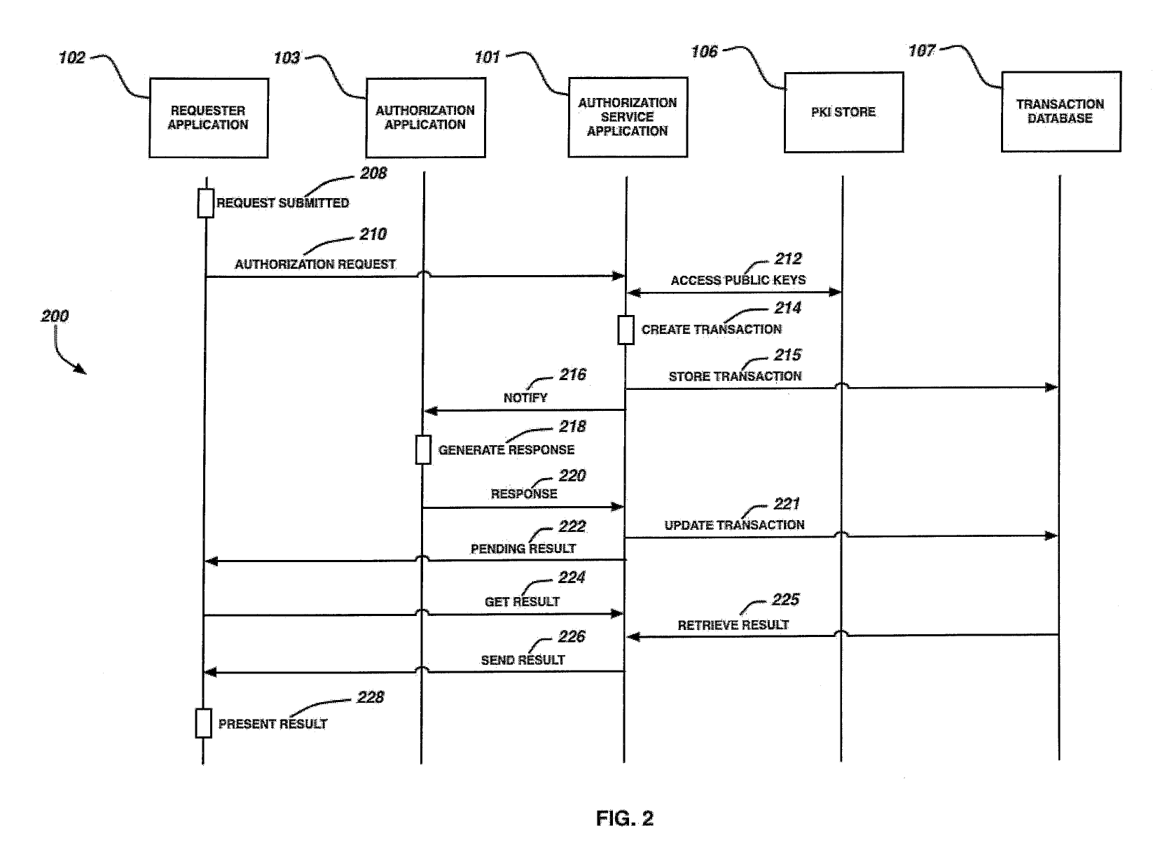

The transaction authorization system operatively fulfills requests for authorization from requestors by obtaining authorizations from authorizers. FIG. 2 represents an authorization process 200 using the authorization transaction system of FIG. 1. The requester initiates an authorization request through requester application 102. The authorizer responds to the authorization request through authorization application 103.

The role of the requester or the authorizer can be realized by a manual entry or by automated processes via a stored program software system. A single stored program application may fulfill both roles depending on the circumstances.

Beginning at step 208 a requester submits an authorization request through requester application 102. At step 210, requester application 102 sends the authorization request through the network to authorization service application 101. At step 212, public key certificates are accessed and a public key retrieved from PKI store 106 based on information in the authorization request such as a user id.

At step 214, authorization service application 101 creates a pending transaction based on the authorization request and, at step 215, stores the pending transaction in transaction database 107. At step 216 authorization service application 101 notifies authorizer application 103 of the pending transaction. At step 218, authorizer application 103 generates a response for the pending transaction by communicating with the authorizer, the response being an approval or a disapproval to authorize the pending transaction based on the public key and a previously stored private key.

At step 220, the response is returned to authorization service application 101. At step 221, the authorization service application updates the pending transaction with the response. At step 222, authorization service application 101 notifies requester application 103 of a pending authorization. Then, at step 224, requester application 102 requests the pending authorization from authorization service application 201. At step 225, authorization service application 201 retrieves the pending transaction from transaction database 107. At step 226, the pending transaction including the result is sent to the requester application 102. At step 228, the result is presented to the requester.

Those skilled in the art will recognize that authorization process 200 enables an electronic form of many types of existing authorizations: website sign-ins, credit card transactions, financial transactions, medical procedure approvals, corporate approvals, document signatures, to name a few. While illustrative embodiments in the present disclosure are described for website sign-ins and credit card transactions, the present disclosure does not preclude other embodiments of the authorization processing system conceived for different purposes.

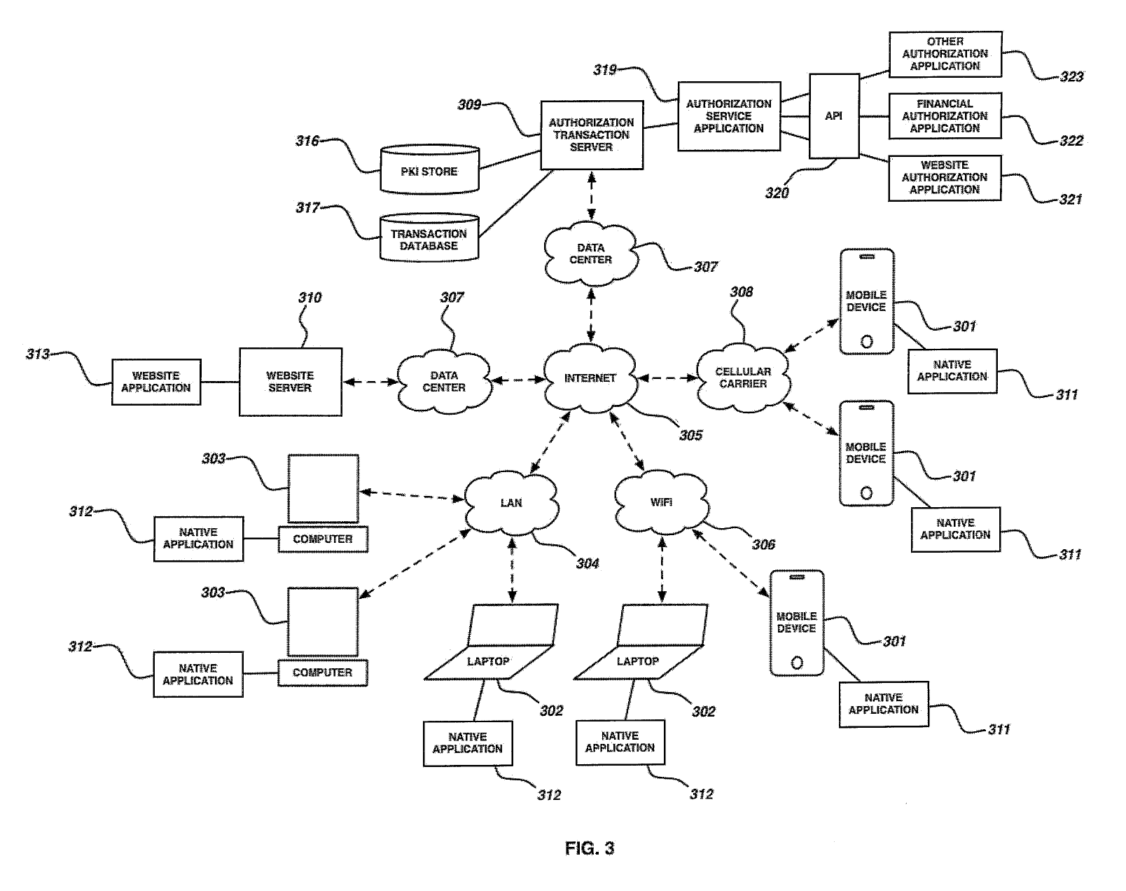

A representative embodiment of an authorization transaction system deployed in a networked environment is shown in FIG. 3, where a set of computers 303, a set of laptops 302 and a set of mobile devices 301 connect to a set of Local Area Networks (LANs) 304, a set of wireless networks (WiFi) 306, a set of cellular networks 308 and set of data center networks 307. LANs 304, WiFi 306, set of cellular networks 308 and set of data center networks 307 are connected to the Internet 305. A website server 310 is connected to Internet 305 via at least one of the set of data center networks 307. An authorization transaction server 309 is also connected to Internet 305 via at least one of the set of data center networks 307.

As is well known to those skilled in the art, LANs, WiFi, cellular networks and the Internet consist of a number of different types of communication equipment manufactured by various companies and compliant with numerous standards. Their common function is to provide peer-to-peer connectivity between computing devices in accordance with TCP/IP and related standards.

In a preferred embodiment, authorization transaction server 309 comprises a specialized hardware system executing an authorization service application 319 that provides an out-of-band, third party, secure and strongly authenticated authorization service. Authorization transaction server further comprises a PM store 316 and a transaction database 317.

Also, in a preferred embodiment, a set of native applications are installed on the set of computers, the set of laptops and the set of mobile devices. The set of native applications comprise a computer authorization application 312 operating on set of computers 303 and set of laptops 302, a web authorization application 313 operating on website server 310, and a mobile authorization application 311 operating on set of mobile devices 301. The set of native applications, when executed by their local processors, carry out methods and implement features necessary to properly cooperate in an authorization process with transaction authorization server 309 carrying out the authorization service application 319.

FIG. 3 also illustrates the communication between various entities involved in an authorization transaction. Computer authorization application 312, web app authorization application 310 and mobile authorization application 311 are applications developed and provided by an authorization service provider that operates the authorization transaction server 309.

Website authorization application 321, financial authorization application 322 and other authorization applications 323 (collectively “third-party applications”) represent stored program applications developed and executed on hardware platforms operated by third-party service providers other than the provider of the authorization transaction service. Authorization service application 319 is connected through application programming interface (API) 320 to the third-party applications. The third party applications utilize API 320 to integrate with authorization service application 319 to coordinate authorization to use their services. These third-party service providers typically have a different main purpose other than authorization (e.g. presenting websites, banking, credit card transactions, etc.) but require authorization and the servicing of authorization requests as a feature of their products and services.

It will be appreciated that API 320 may be implemented and delivered in many forms, including, but not limited to, remote APIs over the HTTP protocol and local APIs in various programming languages.

The preferred embodiment for all communications between these entities uses HTTP over TCP/IP protected with SSL. However, it is appreciated that these entities can accomplish the same tasks using any protocols that can transmit the necessary messages between entities and with the same host authentication properties of SSL.

It should be clearly understood that the native applications and the third-party applications run on separate computing devices from the authorization transaction service application. It should also be understood that the native applications can implement a requester application or an authorizer application as required by the circumstances, and that the third-party applications can also implement a requester application or an authorizer application as required by the circumstances. This is an important aspect of the disclosure.

In use, the system of FIG. 3 supports communications between the various devices and servers to perform authorization functions. Many communications taking place on the Internet involve in-band authentication. A user manipulates an application (typically a web browser) on a computing device in order to access and manipulate resources on website server 310 by establishing a session between the web browser and the website server. Typically, this involves an authentication step which results in authorization to establish a session with access to the desired resources. In the prior art, this authentication step occurs in the same context as the session itself—in this case, within the web browser on the same computing device while transferring authentication data directly between the web browser and the website server.

The features of the present disclosure are based upon recognition of the following:

1.) Authorization is distinct and separate from the subsequent establishment of a session. Therefore, authorization can occur out-of-band from a sessions communication channel. Out-of-band authorization has significant advantages.

2.) Websites and users are beginning to recognize the value of third party authentication and adoption is accelerating. It improves security by reducing the “attack surface” area.

3.) PKIs are typically complicated and costly but provide useful operations and properties. Building and operating a PKI within a confined organizational domain and limiting users' exposure to the details of the implementation can reduce cost and simplify the user experience.

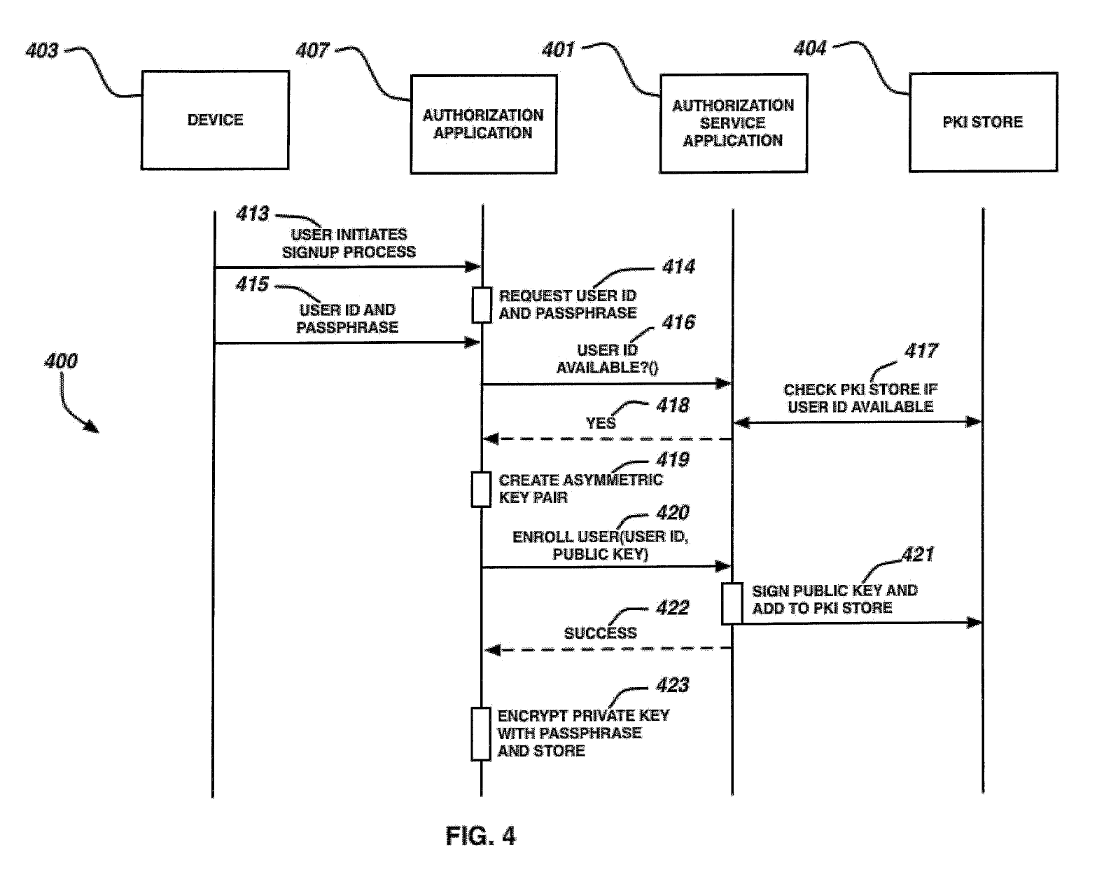

FIG. 4 is a system flow diagram that illustrates a registration process 400 necessary to “register” a user's device so the user's device can participate in authorization requests as a requestor or authorizer. The authorization application 407 represents a native authorization application operating on a device 403. Device 403 represents any of the desktop computer, the laptop computer and the mobile device as depicted in FIG. 3. Device 403 includes a user interface for presenting information to a user and collecting information from the user. Authorization service application 401 and PKI store 404, operated by the authorization transaction server, are also used in the registration process.

At step 413, the registration process begins by manipulating authorization application 407 to initiate a signup process. The authorization application at step 414 manipulates the user interface to request a user id and a passphrase from device 403. The requested user id and requested passphrase is entered and provided to authorization application at step 415.

At step 416, authorization application 407 checks with authorization service application 401 to determine if the requested user id is available. At step 417, authorization service application 401 accesses PM store 404 to see if the requested user id has not already been used. If the requested user id is available (the not available case is not shown but the proper user interface interactions are understood by those skilled in the art), the result is returned at step 418 to authorization application 407.

At step 419, authorization application 407 generates an asymmetric encryption key-pair. In the preferred embodiment, an RSA key-pair is used, but alternative embodiments can use any asymmetric encryption technology that has encryption and signature operations and properties that key-pairs to be managed and issued via a PKI. The preferred embodiment uses a single key-pair of 1024 bit strength, but those practiced in the art will recognize the option and advantages of using larger bit keys and of using multiple key-pairs to separate encryption operations from signing operations.

At step 420, authorization application 407 generates a request to the authorization service application 401 to enroll the user with the specified user id and public key from the previously generated key-pair.

At step 421, authorization service application 401 signs the public key and stores a certificate, associated with the specified user id, in PKI store 404. At step 422, a success indication is returned to authorization application 407.

At step 423, authorization application 407 encrypts the private key from the previously generated key pair using a symmetric encryption algorithm with a key derived from the passphrase. In the preferred embodiment, AES256 is used for encryption and PBKDF2 is used for key derivation but alternative embodiments can use other encryption and derivation functions that meet appropriate levels of security.

At this point, one will appreciate a crucial aspect of the present invention. A naïve approach would use an architecture where separate stored programs are not required for authorization transactions. For instance, a web browser on device 403 could be accessed directly by requesters and authorizers rather than through dedicated authorization applications. However, such a process results in a myriad of security issues because each device or software system on a device turns over the management of their secret key to the web server, accessed by the web browser, for the sake of implementation expedience.

By having separate stored program authorization applications, a number of security advantages are realized:

1.) The problem of trying to steal secret keys is distributed amongst many physical computing device domains. If a miscreant wishes to gather X secret keys, he must attack X number of separate domains.

2.) The authorization requests can be encrypted and rendered opaque to the authorization transaction service itself. Any attack on the authorization transaction service itself will not yield information about transactions.

3.) The authorization requests can be strongly authenticated with little reliance on the security of the authorization transaction service. Authorization applications need only depend upon the security of the root certificate for the PKI store. Any other breach or security issue with the authorization transaction service will not result in the ability for a transaction to be falsified.

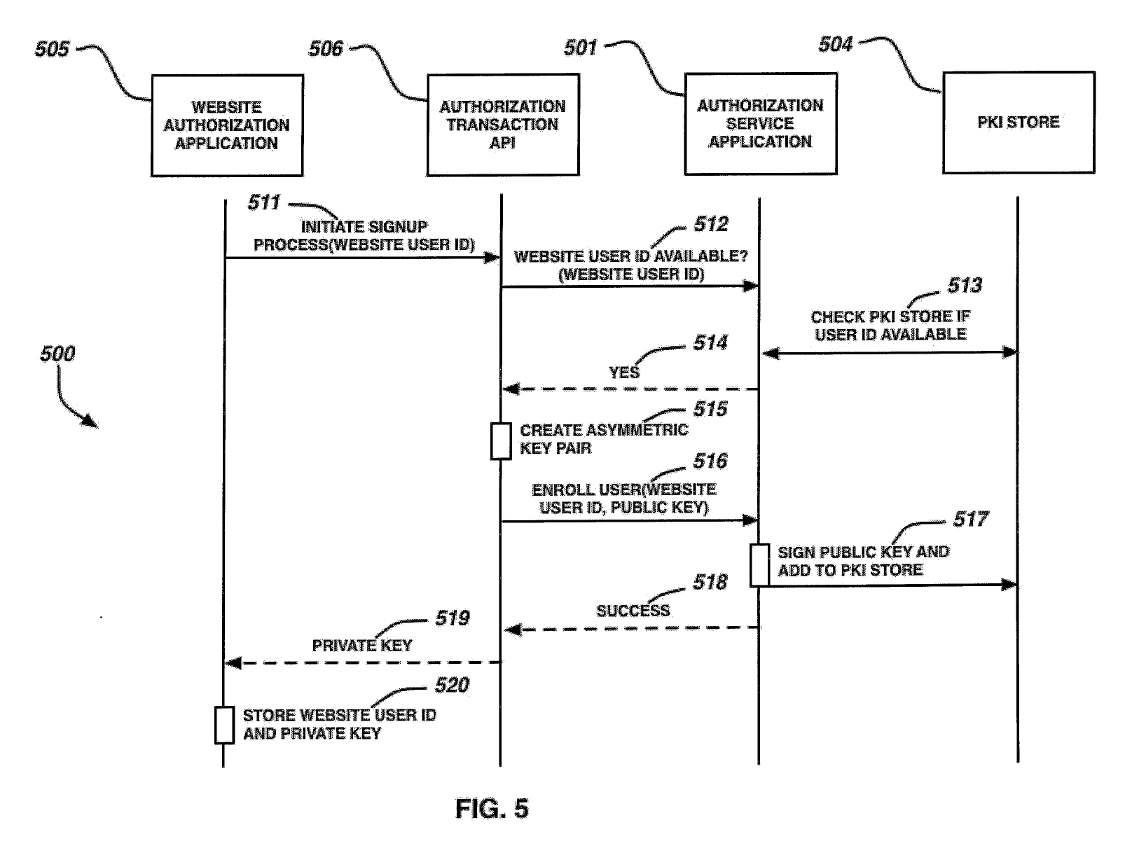

FIG. 5 is a system flow diagram that illustrates the registration process 500 necessary to “register” a third-party application so it can participate in authorization requests as a requestor or authorizer. Website authorization application 505 is a representative example of all third party applications as defined previously: registration process 500 works in a similar fashion for credit card authorization applications and other authorization applications. Registration process 500 involves communications between website authorization application 505 and authorization service application 501 using API 506. Further communications are required between authorization service application 501 and PKI store 504.

At step 511, website authorization application 505 initiates a signup process using API 506, wherein website authorization application 505 specifies a desired website user id to API 506. This website user id is in the same “namespace” as a normal user id and is only referred to as “website user id” to distinguish the two cases.

At step 512, API 506 checks with authorization service application 501 to determine if the requested website user id is available. At step 513, authorization service application 501 accesses PKI store 504 to see if the requested user id has not already been used. Presuming that it is available (the not available case is not shown but the proper API return codes and API features are understood by those skilled in the art), the result is returned at step 514 to the API.

At step 515, API 506 generates an asymmetric encryption key-pair. In the preferred embodiment, an RSA key-pair is used, but alternative embodiments can use any asymmetric encryption technology that has encryption and signature operations and properties that key-pairs are managed and issued via a PKI. At step 516, API 506 generates a request to authorization service application 501 to enroll the user with the specified website user id and public key from the previously generated key-pair.

At step 517, authorization service application 501 signs the public key and stores the certificate associated with the specified website user id in PKI store 504. At step 518, a success indication is returned to API 506.

At step 519, API 506 returns the private key from the previously generated key pair to the website authorization application which, at step 520, persistently stores the website user id and private key so that they can be retrieved for future interactions with API 506.

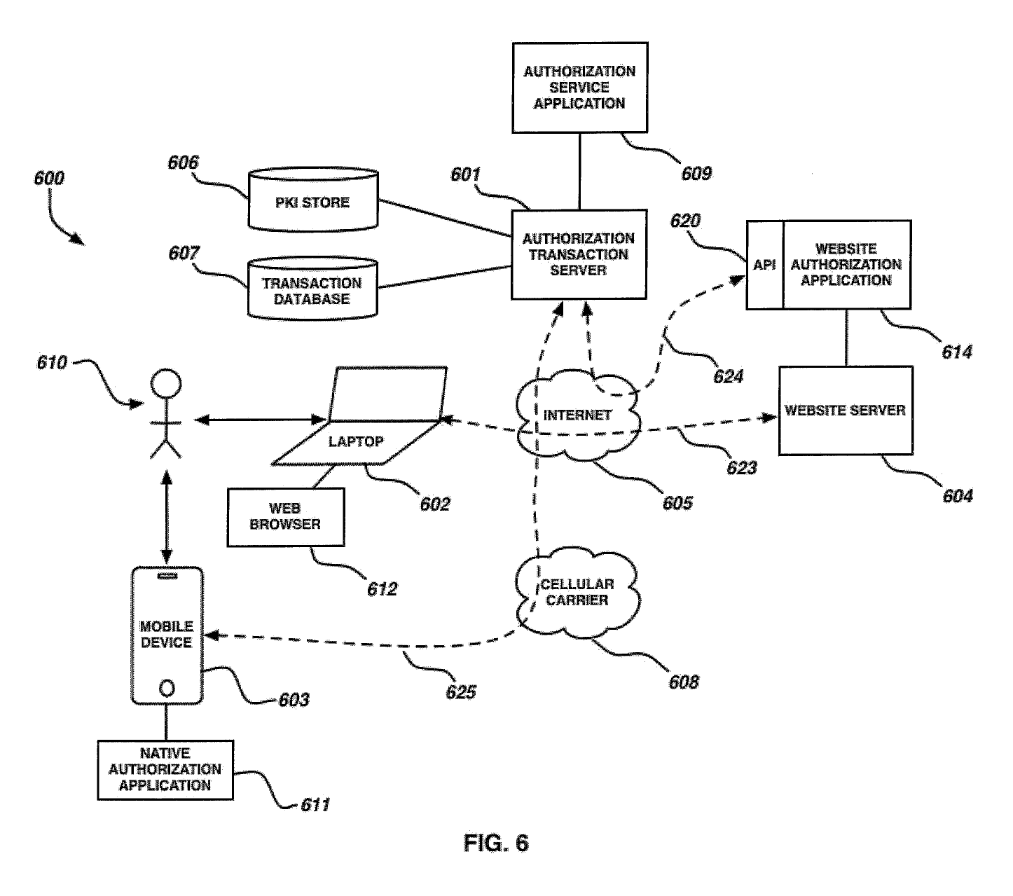

FIG. 6 is a block diagram for an example system configuration 600 for servicing an out-of-band authorization request for a sign-in to a website. User 610 manipulates a laptop 602 hosting a web browser 612 with access to Internet 605. User 610 also manipulates a mobile device 603 which executes a native application 611, provided and maintained by an authorization service provider.

Web browser 612 is in communication over “in-band” communication path 623 with website server 604 through the Internet 605. Website server 604 executes a website authorization application 614, provided and maintained by the authorization service provider.

An authorization transaction server 601, also provided by the authorization service provider is connected to Internet 605 and is in communication with website application 614 over “out-of-band” communication path 624 and through API 620. Authorization transaction server 601 is also in communication with native application 611 over “out-of-band” communication paths 625. Out-of-band communication path 625 traverses a cellular carrier network 608 connected to Internet 605. Authorization transaction server 601 comprises an authorization service application 609 for processing authorization transactions, a PKI store 606 for manipulating private and public keys and a transaction database 607 for storing authorization transactions.

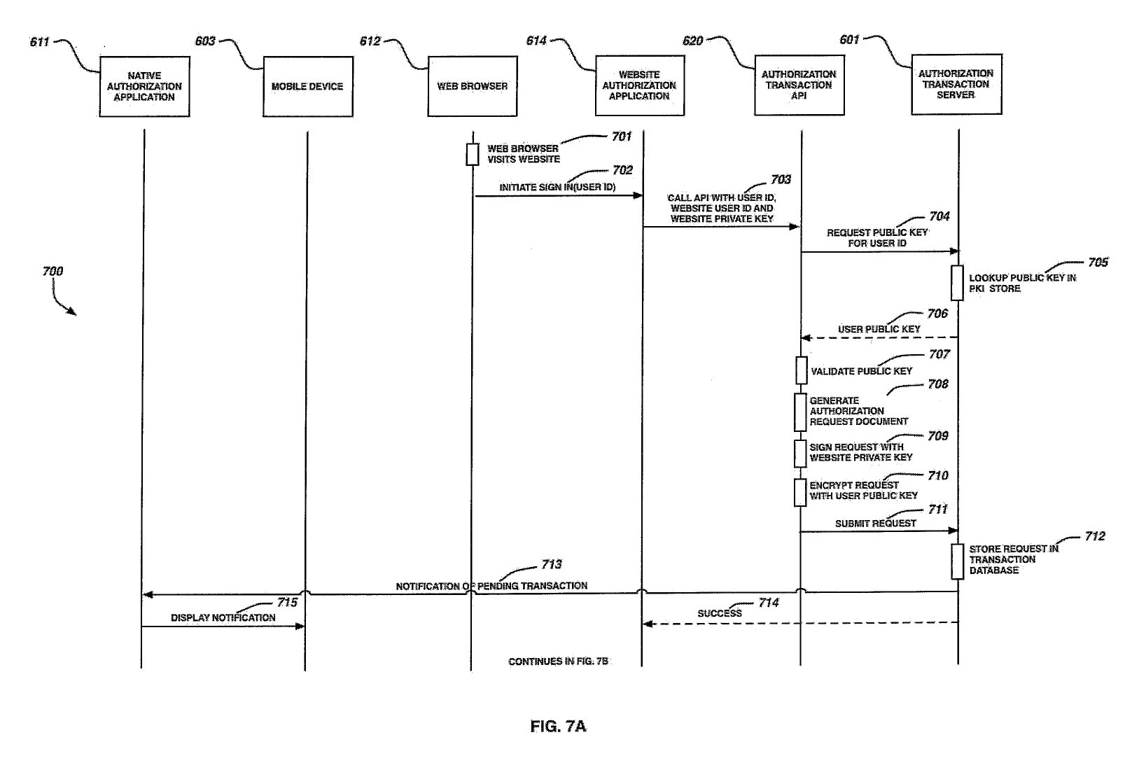

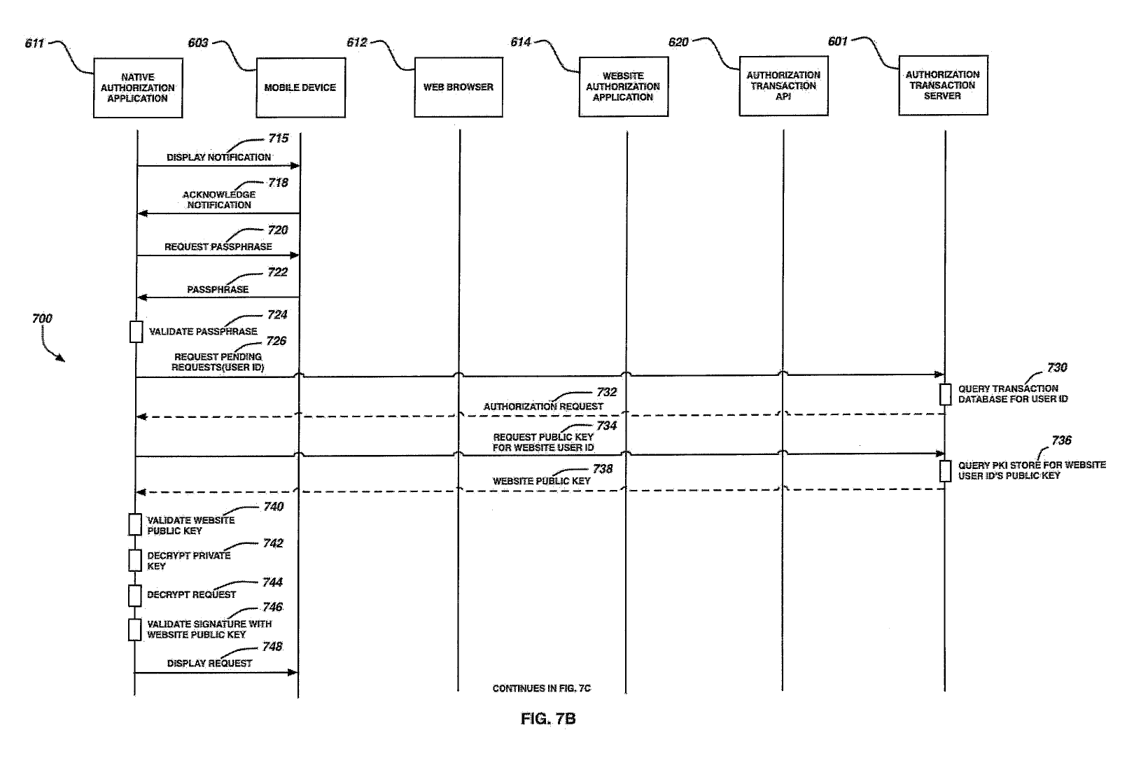

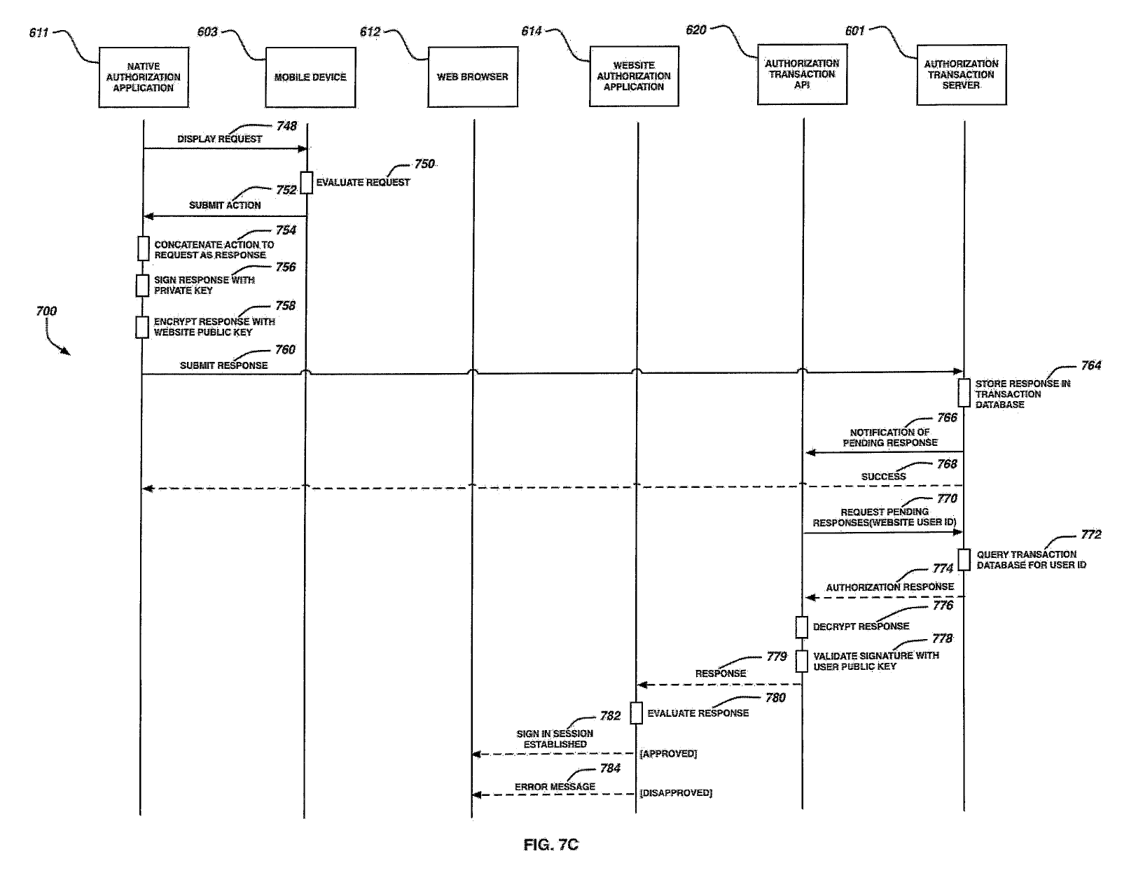

FIGS. 7A, 7B and 7C are a system flow diagram that describes an example website sign-in authorization process 700 illustrated using the system configuration 600 of FIG. 6.

Beginning in FIG. 7A, at step 701, web browser 612 is launched by user 610 and accesses protected resources. Website authorization application 614 is started when web browser 612 accesses the protected resources. At step 702, website authorization application 614 and web browser 612 perform a sign in process resulting in a requester user id.

In a preferred embodiment, at step 702, the communications between web browser 612 and website authorization application 614, is over the “in-band” communication path. With the exception of steps 701, 702, 782 and 784, all other steps in FIGS. 7A, 7B and 7C requiring communications between entities are carried out over the “out-of-band” communication path.

At step 703, website authorization application 614 accesses the authorization transaction server 601 through API 620 to initiate an authorization request using an authorizer user id. In step 703, the requester user id, the authorizer user id and the website public key are provided to API 620. It should be understood that the website public key was stored previously in authorization transaction server 601 as a result of a registration process as described in FIG. 4.

At step 704, API 620 sends a request for a public key to authorization transaction service 601, where the public key is associated with the authorizer user id. At step 705, authorization transaction server 601 performs a lookup in PM store 606 for the correct public key certificate associated with the authorizer user id and returns the public key at step 706 to API 620.

At step 707, API 620 validates the public key is valid. As discussed previously, this step is the only tangible security threat that the authorization transaction server can represent to requesters and authorizers. If the authorization transaction server's root private key is compromised, public key certificates can be generated by miscreants that would be indistinguishable from normal public key certificates. The preferred embodiment has a single root key but those practiced in the art will realize that multiple levels of chained certificates with varying bit strengths can be used to increase security and reduce the effects of a compromised signing private key.

At step 708, API 620 generates a request document for the content of the authorization request and returns it to the website authorization application. The preferred embodiment of the request document uses JavaScript Object Notation (JSON) but may take alternative forms such as XML, HTML, ASN.1 or others. The purpose of the request document is to represent the authorization in a request in such a way that both the website authorization application 614 (acting as the requester in this example) and native authorization application 611 (acting as the authorizer in this example) can both interpret, display and provide appropriate response. As such, the request document contains information such as the requester user id, the website being accessed, the time of day, the IP address of the device requesting access, etc.

In another embodiment, step 708 invokes the generation of a “correlation token”. A correlation token is meant to be seen by a human and used to correlate an authorization request presented by an authorization application with the request being handled by the requester. For instance, in the block diagram of FIG. 6, the correlation token would be displayed in the web browser and on the mobile device. This prevents a miscreant from exploiting race conditions in order to trick a user to authorizing the wrong request. If the miscreant and the user both request sign in to the same website simultaneously, even if the miscreant's request is processed first, the correlation token will not match what is displayed to the user in their web browser.

At step 709, API 620 signs the request with the website private key. This prevents other users of the system from forging authorization requests for any particular user id.

At step 710, API 620 encrypts the request with the user's public key. This prevents other users or the authorization transaction service from viewing the contents of the request.

At step 711, API 620 submits the authorization request to authorization transaction server 601 after which the authorization transaction server, at step 712, creates a corresponding transaction and stores it in the transaction database.

At step 713, authorization transaction server 601 notifies native authorization application 611 of a pending transaction for the user. It is appreciated that there are a number of existing mechanisms to remotely notify an executing program application on a computing device and to associate the information necessary to invoke these mechanisms within the PKI store. The present disclosure is not limited by any particular choice of notification mechanisms as long as they support the basic communication patterns described in this system flow.

At step 714, a success indication is returned to website authorization application 614. At step 715, native authorization application 611 displays the notification of a pending request on the mobile device.

Continuing with FIG. 7B, at step 718, the notification is acknowledged by a user action in the web browser in response to step 715. At step 720, native authorization application 611 requests a passphrase. At step 722, the passphrase is provided.

It will be appreciated that steps 720 and 722 do not have to occur at this point in every transaction authorization request. The native authorization application can support an “unlocked” state where this information is cached and does not need to be requested and entered each time. This represents a trade-off in security vs. convenience for the user. The user does not have to enter the passphrase each time but exposes themselves to the risk that a miscreant can access the native authorization application in an unlocked state and authorize authorization requests that the user would not approve.

The present disclosure utilizes the reception of a passphrase for authentication. It should be understood that the present invention is not limited by a particular authentication method. For example, a biometric type authentication could be used instead of a passphrase.

At step 724, the passphrase is validated by native authorization application 611 to ensure it has been entered properly.

At step 726, native authorization application 611 generates a request to authorization transaction server 601 for a list of pending authorizations for the user. At step 730, the authorization transaction server queries the transaction database and generates the list of pending authorizations. In this example, a pending authorization request is returned at step 732. At step 734 the website public key for the website user id is requested from authorization transaction server 601. At step 736, the website public key is looked up in the PKI store. At step 738 the website public key is returned to native authorization application 611.

At step 740, the authenticity of the website public key is verified. At step 742, the passphrase, validated from step 724, is used to derive the necessary encryption key and decrypt a mobile private key. It should be understood that the mobile private key was stored locally in the mobile authorization application as a result of a registration process as described in FIG. 3.

At step 744, the private key is used to decrypt the request document that was generated at step 708. At step 746, the signature generated at step 709 is validated.

It will be appreciated that any of steps 740, 742, 744 and 746 could fail. Failure would indicate either problems with the system or more likely an attempt to forge an authorization request. In a preferred embodiment, failure of any of these steps results in an error report being displayed on mobile device 602 and the discarding of the request.

Once validated, the request document is interpreted by the native authorization application and, at step 748, an appropriate user interface is generated by mobile device 602 and presented to the user for the display of the request and capture of user response.

Continuing with FIG. 7C, after step 748, starting with step 750, the displayed request is evaluated on the mobile device. At step 752, the desired action is submitted, in this case an approval or denial of the request.

It will be appreciated that many types of user actions might be appropriate and specified as valid by the request document. For instance, approval may be tentative, conditional on a condition external to the authorization processing system, conditional on a change to the parameters of the request (e.g., change the dollar amount or account number of a transfer, etc.). The simplest case of approval or denial of a request as illustrated here is not meant to exclude these other possibilities. In an alternate embodiment, the display request at step 750 may include a correlation token in order to prevent the approval of unwanted requests.

At step 754, the mobile authorization application converts the user action into a form suitable for concatenation to the original request document and performs the concatenation to produce a response document. At step 756, the response document is signed with the mobile private key and at step 758 it is encrypted with the website public key. These steps result in the desirable system properties that other users of the system are prevented from forging authorization requests for any particular user id and that other users or the authorization transaction service are prevented from viewing the contents of the response document. The process also ties the response to the request in such a way as to be non-reputable.

At step 760, native authorization application 611 submits the response document to authorization transaction server 601. At step 764, authorization transaction server 601 stores the response document with the existing transaction in the transaction database and, at step 766, notifies website authorization application 614. At step 768, a success indicator is returned to native authorization application 611.

At step 770, API 620 requests pending responses from the authorization transaction server for the website user id. At step 772, the authorization transaction server looks up any pending authorization responses for the website user id and at step 774 returns a pending response document.

At step 776, API 620 uses its private key to decrypt the pending response document. At step 778, the signature on the pending response document is validated and, at step 779, the pending response document is sent to the website authorization application.

At step 780, the pending response document is evaluated for approval. If approved, then step 782 is performed wherein website authorization application 614 opens a web session for website user id on the same “in-band” communication path that initiated the sign in request at step 702. If not approved, then step 784 is performed which sends an appropriate error message to the web browser.

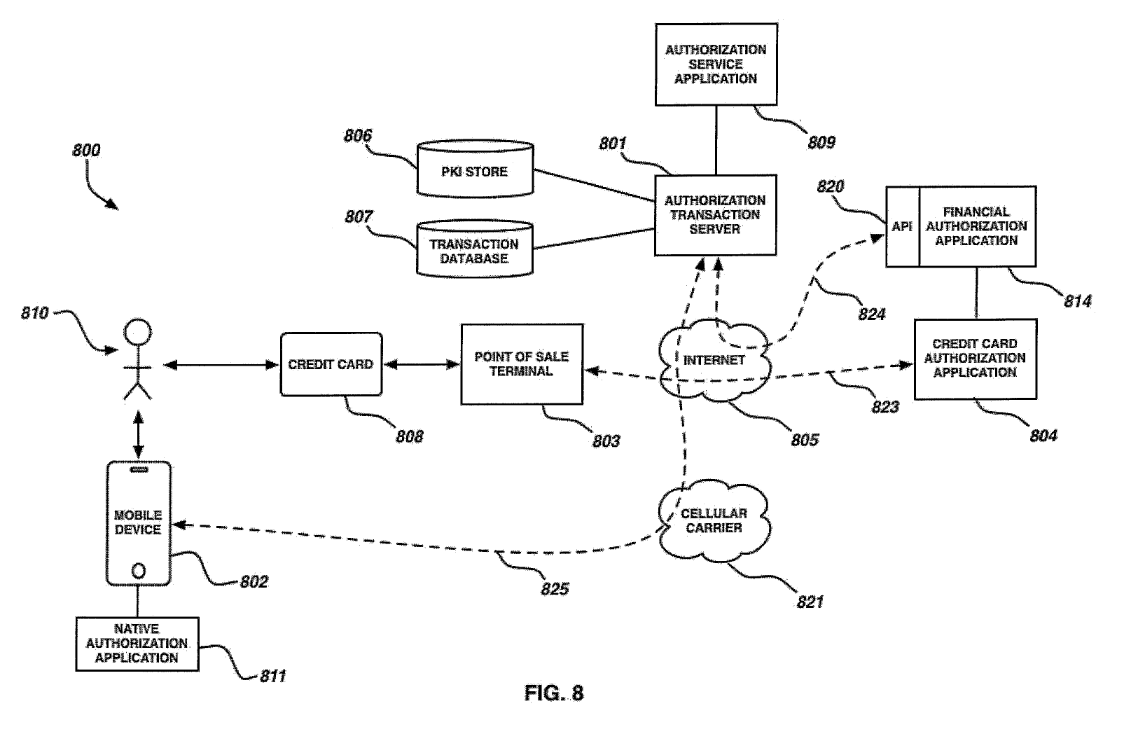

FIG. 8 represents a system configuration 800 illustrative of an authorization request for a credit card transaction.

Card holder 810 presents a credit card 808 in order to complete a purchase with a retailer over a Point of Sale (PoS) terminal 803 which performs a credit card transaction. PoS terminal 803 is connected via Internet 805 to credit card authorization server 804. In another embodiment, the credit card transaction takes place over other communication paths using means other than the Internet. In a preferred embodiment, PoS terminal 803 is in communication over an “in-band” communication path 823 with credit card authorization server 804.

Card holder 810 also manipulates a mobile device 802 operating a native application 811 which is provided and maintained by an authorization service provider.

Credit card authorization server 804 executes financial authorization application 814, provided and maintained by the authorization service provider.

An authorization transaction server 801, also provided by the authorization service provider is connected to Internet 805 and is in communication with authorization application 804 through API 820 over “out-of-band” communication path 824. Authorization transaction server 801 is also in communication with native application 811 over “out-of-band” communication path 825. Out-of-band communication path 825 traverses a cellular carrier network 821 connected to the Internet 805. Authorization transaction server 801 comprises an authorization service application 809 for processing authorization transactions, a PKI store 806 for manipulating private and public keys and a transaction database 807 for storing authorization transactions.

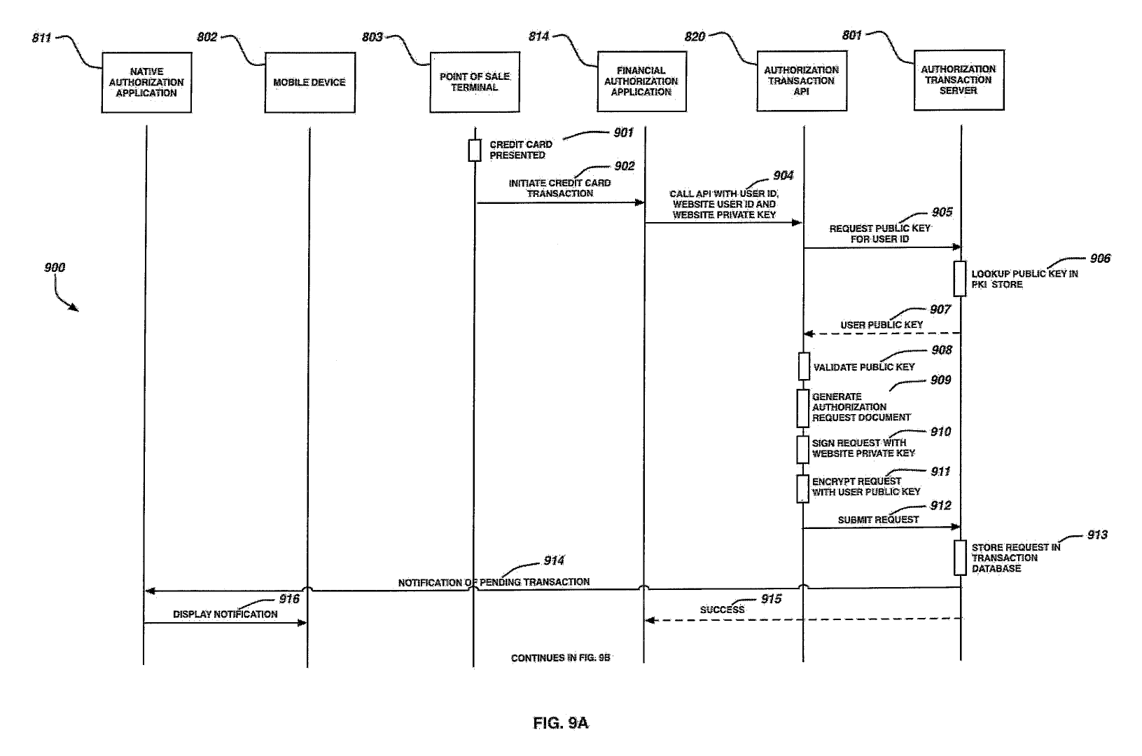

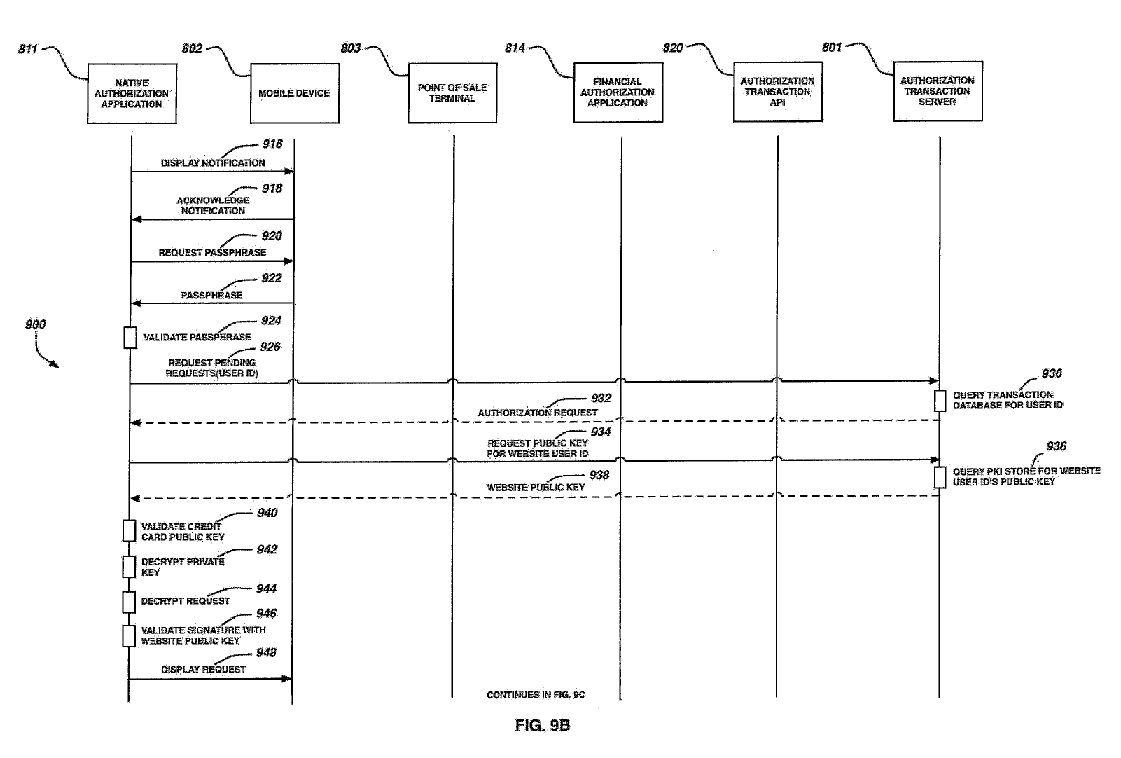

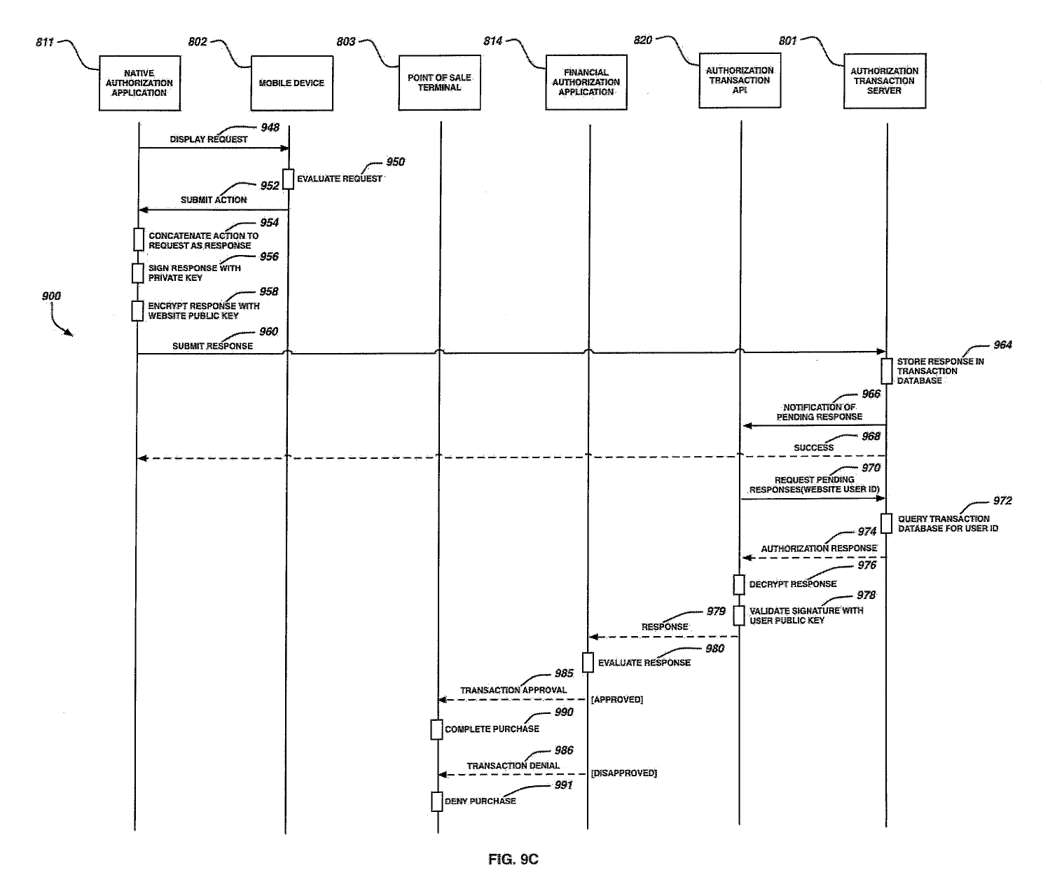

FIGS. 9A-9C depict a system flow diagram of a preferred embodiment of a credit card authorization process 900 involved in the credit card transaction authorization request conducted by the system depicted in FIG. 8.

In a preferred embodiment, the communications between PoS terminal 803 and credit card authorization server 804 at step 902 is over the “in-band” communication path. With the exception of steps 902, 985, 986, 990 and 991, all other steps in FIGS. 9A, 9B and 9C requiring communications between entities are carried out over the “out-of-band” communication path.

At step 901, a credit card is presented at PoS terminal 803 in order to complete a financial transaction. At step 902, PoS terminal 803 sends a credit card transaction to financial authorization application 814. At step 903, financial authorization application 814 looks up a card user id and a credit card private key associated with the credit card. It should be understood that the credit card private key was stored previously in the authorization transaction server as a result of a registration process as described in FIG. 4.

At step 904, credit card authorization application 814 accesses authorization transaction server 801 through API 820 to initiate an authorization request using an authorizer user id. At step 904, the card user id, the authorizer user id and a credit card private key are provided to API 820.

At step 905, API 820 requests from authorization transaction server 801 a public key associated with the authorizer user id. At step 906, the authorization transaction service performs a lookup in the PKI store for the correct public key certificate associated with user id and, at step 907, returns the public key to API 820.

At step 908, API 820 verifies the public key is valid. If the public key is valid the process continues at step 909. If the public key is not valid, then the process is terminated and an error message is returned to PoS terminal 803.

At step 909, API 820 generates a request document for the content of the authorization request. The preferred embodiment of the request document uses JavaScript Object Notation (JSON) but may take alternative forms such as XML, HTML, ASN.1 or others. The purpose of the request document is to represent the authorization in a request in such a way that both the financial authorization application 814 (acting as the requester in this example) and native authorization application 811 (acting as the authorizer in this example) can both interpret, display and provide appropriate response. As such, the request document contains information such as the card user id requesting authorization, the website being accessed, the time of day, the IP address of the device requesting access, etc.

In another embodiment, step 909 invokes the generation of a “correlation token”. A correlation token is meant to be seen by a human and used to correlate an authorization request presented by an authorization application with the request being handled by the requester. For instance, in the block diagram of FIG. 8, the correlation token would be displayed or printed by the PoS terminal and displayed on the mobile device. This prevents a miscreant from exploiting race conditions in order to trick a user to authorizing the wrong request. If the miscreant and the user both request sign in to the same website simultaneously, even if the miscreant's request is processed first, the correlation token will not match what is displayed to the user by the PoS terminal.

At step 910, financial authorization application 814 signs the request with the credit card private key. This prevents other users of the system from forging authorization requests for any user id.

At step 911, financial authorization application 814 encrypts the request with the credit card public key. This prevents other users or the authorization transaction service from viewing the contents of the request.

At step 912, financial authorization application 814 submits the authorization request to the authorization transaction server which creates a transaction and, at step 913, stores it in the transaction database.

At step 914, authorization transaction server 801 notifies native authorization application 811 of a pending transaction for the card holder. It is appreciated that there are a number of existing mechanisms to remotely notify an executing program application on a computing device and to associate the information necessary to invoke these mechanisms within the PKI store. The present disclosure is not limited by any particular choice of notification mechanisms as long as they support the basic communication patterns described in this system flow.

At step 915, a success indication is returned to financial authorization application 814. At step 916, native authorization application 811 displays the notification of a pending request on the mobile device.

Continuing with FIG. 9B, at step 918, the notification displayed in step 916 is acknowledged. At step 920, the mobile authorization application requests a passphrase. At step 922, the passphrase is provided.

It will be appreciated that steps 920 and 922 do not have to occur at this point in every transaction authorization request. The mobile authorization application can support an “unlocked” state where this information is cached and does not need to be requested and entered each time.

At step 924, the passphrase is validated by native authorization application 811 to ensure it has been entered properly.

When a validated passphrase is entered, step 926 is performed where native authorization application 811 generates a request to authorization transaction server 801 for a list of pending transactions for the card holder. At step 930, authorization transaction server 801 queries the transaction database and generates the list of pending transactions. In this example, a pending authorization request is returned at step 932. At step 934 the credit card public key for the card user id is requested from the authorization transaction server. At step 936, the credit card public key is looked up in the PKI store and, at step 938, the credit card public key is returned to native authorization application 811.

At step 940, the authenticity of the credit card public key is verified. At step 942, the passphrase, validated from step 924, is used to derive the necessary encryption key and decrypt a mobile private key. It should be understood that the mobile private key was stored locally in the native authorization application as a result of a registration process as described in FIG. 5.

At step 944, the private key is used to decrypt the request document that was generated at step 909. At step 946, the signature generated at step 910 is validated.

It will be appreciated that any of steps 940, 942, 944 and 946 could fail. Failure would indicate either problems with the system or more likely an attempt to forge an authorization request. In a preferred embodiment, failure of any of these steps results in an error report being displayed on mobile device 802 and the discarding of the request.

Once validated, the request document is interpreted by the native authorization application and, at step 948, an appropriate user interface is generated by mobile device 802 and presented to the card holder for the display of the request and capture of card holder response.

Continuing with FIG. 9C, at step 950, the displayed request from step 948 is evaluated. At step 952, the desired action is submitted, in this case an approval or denial of the request.

It will be appreciated that many types of card holder actions might be appropriate and specified as valid by the request document. For instance, approval may be tentative, conditional on a condition external to the authorization processing system, conditional on a change to the parameters of the request (e.g. change the dollar amount or account number of a transfer), etc. The simplest case of approval or denial of a request as illustrated here is not meant to exclude these other possibilities. In an alternate embodiment, the display request at step 948 may include a correlation token in order to prevent the approval of unwanted requests.

At step 954, native authorization application 811 converts the card holder action into a form suitable for concatenation to the original request document and performs the concatenation to produce a response document. At step 956, the response document is signed with the mobile private key and at step 958 it is encrypted with the credit card public key.

At step 960, native authorization application 811 submits the response document to authorization transaction server 801. At step 964, authorization transaction server 801 stores the response document with the existing transaction in the transaction database and, at step 966, notifies financial authorization application 814. At step 968, a success indicator is returned to native authorization application 811.

At step 970, financial authorization application 814 requests pending responses from authorization transaction server 801 for the card user id. At step 972, authorization transaction server 801 looks up any pending authorization responses for the card user id and, at step 974, returns a pending response document.

At step 976, financial authorization application 814 uses its private key to decrypt the pending response document. At step 978, the signature on the pending response document is validated and, at step 979, the pending response document is sent to the financial authorization application.

At step 980, the pending response document is evaluated for approval. If the pending response document is approved then step 985 is performed wherein a transaction approval message is returned to PoS terminal 803 on the same “in-band” communication path that initiated the sign in request at step 902. At step 990, the retailer completes the purchase.

If, after step 980, the pending response document is disapproved or not approved in a timely manner, then step 986 is performed wherein a transaction canceled message is returned to PoS terminal 803. Then at step 991 the retailer communicates the message to the card holder.

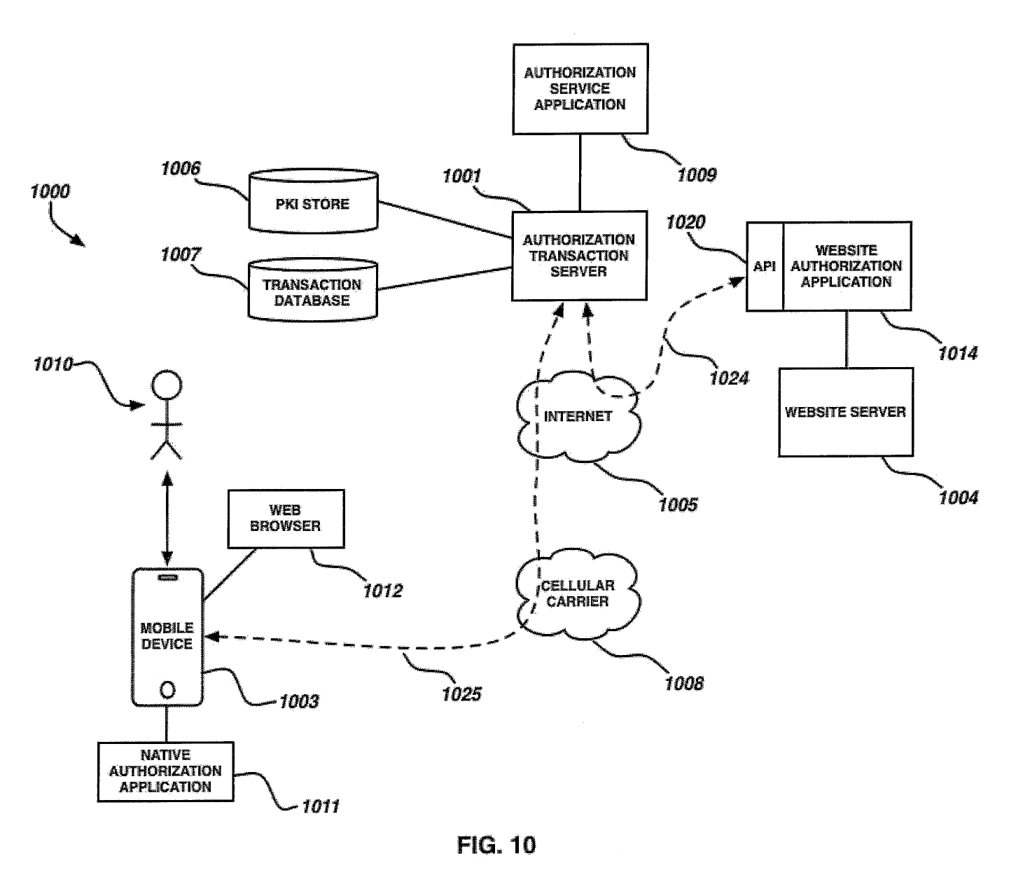

FIG. 10 is a block diagram for an example system configuration 1000 for servicing an authorization request for a sign-in to a website. User 1010 manipulates a device 1003 hosting a web browser 1012 with access to Internet 1005. Device 1003 also executes a native application 1011, provided and maintained by an authorization service provider. Native application 1001 includes a local database for storing website information.

Web browser 1012 is in communication over “in-band” communication path 1023 with website server 1004 through the Internet 1005. Website server 1004 executes a website authorization application 1014, provided and maintained by the authorization service provider.

An authorization transaction server 1001, also provided by the authorization service provider is connected to Internet 1005 and is in communication with website application 1014 over “out-of-band” communication path 1024 and through API 1020. Authorization transaction server 1001 is also in communication with native application 1011 over “out-of-band” communication paths 1025. Out-of-band communication path 1025 can traverse additional networks 1008 connected to Internet 1005, for example, a cellular network. Authorization transaction server 1001 comprises an authorization service application 1009 for processing authorization transactions, a PKI store 1006 for manipulating private and public keys and a transaction database 1007 for storing authorization transactions.

In FIG. 10, device 1003 is depicted as a mobile device and network 1008 is depicted as a cellular network, however, the method is not limited to using a mobile device over a cellular network. For example, device 1003 could be a desktop computer or a laptop computer connected to the internet through a WiFi network.

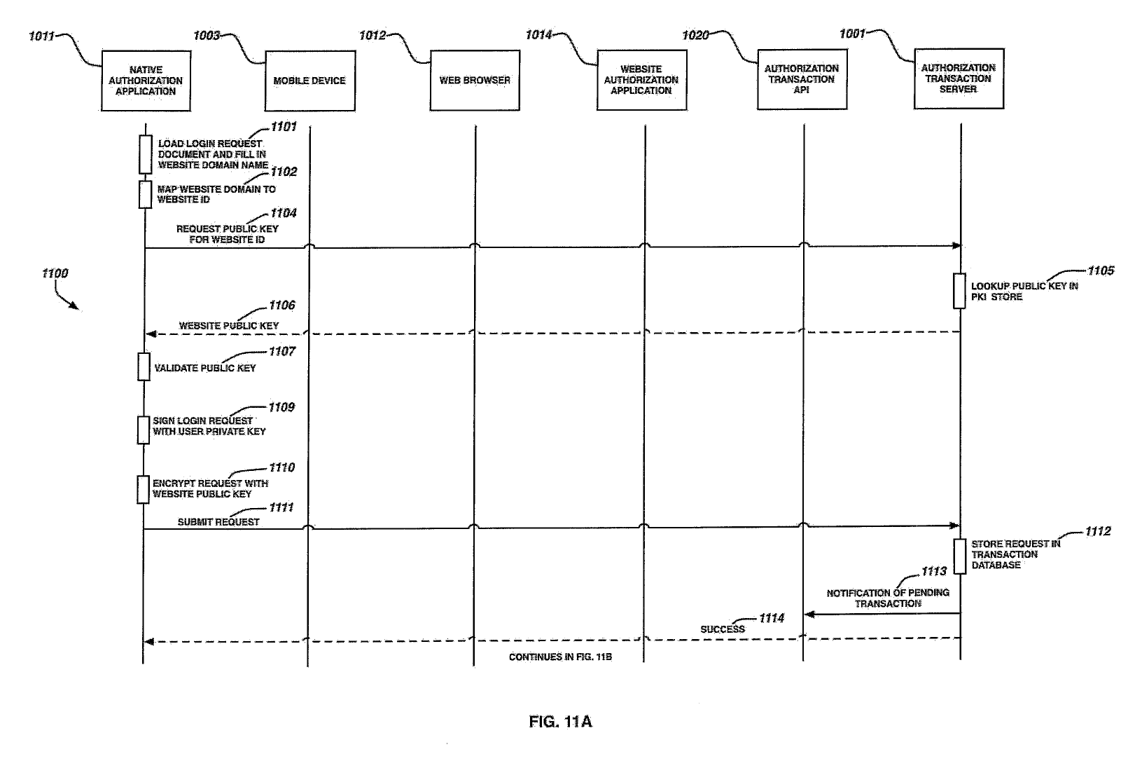

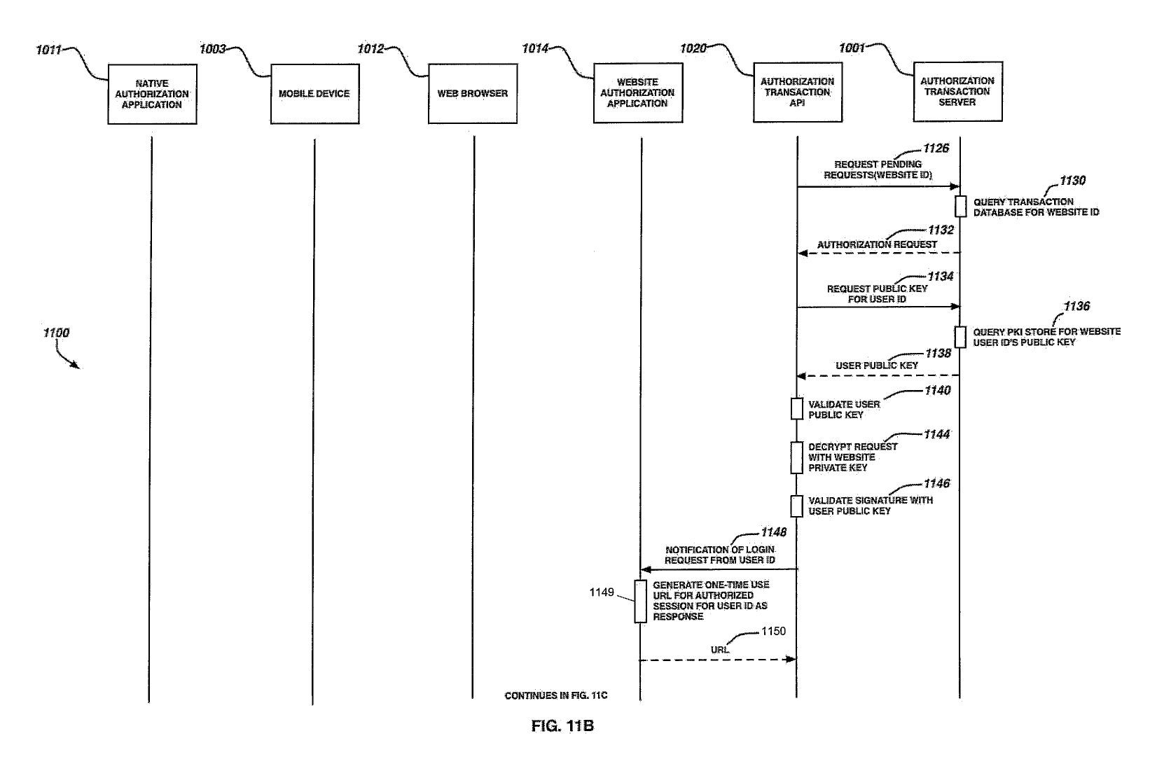

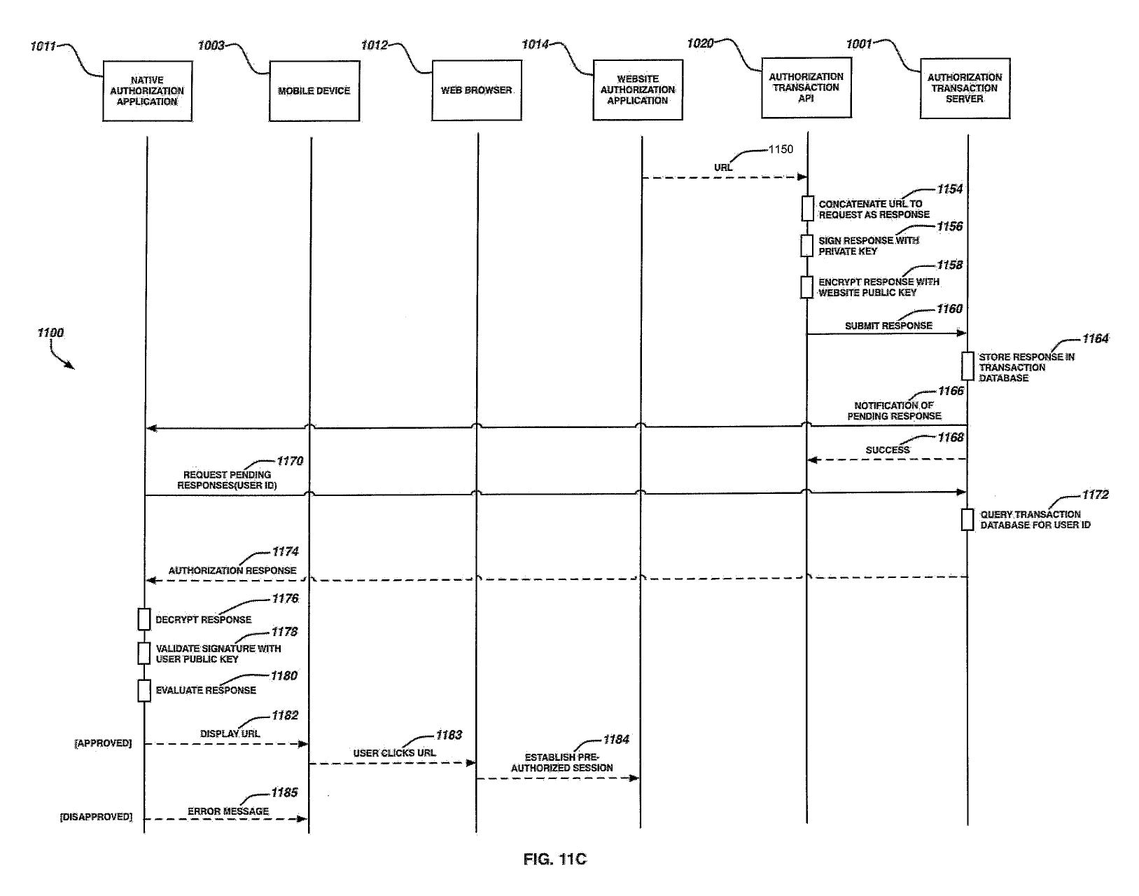

FIGS. 11A, 11B and 11C are a system flow diagram that describes an example website sign-in authorization process 1100 illustrated using the system configuration 1000 of FIG. 10.

Beginning at step 1101, native authorization application 1011 receives and loads a login request including a website domain name. The login request is usually received through a user interface to device 1003. At step 1102, a website id is looked up for the website domain in the local database of the native authorization application.

At step 1104, native authorization application 1011 sends a request for a public key to authorization transaction service 1101, where the public key is associated with the website id. At step 1105, authorization transaction server 1001 performs a lookup in PKI store 1006 for the correct public key certificate associated with the website user id and returns the website public key at step 1106 to the native authorization application.

At step 1107, native authorization application 1011 validates the website public key is valid. At step 1109, native authorization application 1011 generates and signs a login request document with a user private key. The preferred embodiment of the login request document uses JavaScript Object Notation (JSON) but may take alternative forms such as XML, HTML, ASN.1 or others. The purpose of the login request document is to represent the authorization in a request in such a way that both the website authorization application 1014 (acting as the authorizor in this example) and native authorization application 1011 (acting as the requester in this example) can both interpret, display and provide appropriate response. As such, the login request document contains information such as the website id, the website domain, the time of day, the IP address of the device requesting access, etc.

At step 1110, native authorization application 1011 encrypts the request with the website public key. This prevents other users or the authorization transaction service from viewing the contents of the request.

At step 1111, native authorization application 1011 submits the authorization request to authorization transaction server 1001 after which the authorization transaction server, at step 1112, creates a corresponding transaction and stores it in the transaction database.

At step 1113, authorization transaction server 1001 notifies API 1020 of a pending website transaction. At step 1114, a success indication is returned to native authorization application 1011.

Continuing with FIG. 11B, at step 1126, API 1020 generates a request to authorization transaction server 1001 for a list of pending authorizations for the website id. At step 1130, the authorization transaction server queries the transaction database and generates the list of pending authorizations. In this example, a pending authorization request is returned at step 1132. At step 1134, a public key is requested from authorization transaction server 1101. At step 1136, a public key is looked up in the PKI store. At step 1138 the website public key is returned to native authorization application API 1020.

At step 1140, the authenticity of the website public key is verified.

At step 1144, the website private key is used to decrypt the login request document that was generated at step 1109. At step 1146, the signature generated at step 1109 is validated with the website public key. It should be understood that the website private key was stored locally in the API as a result of a registration process as described in FIG. 5.

It will be appreciated that any of steps 1140, 1144 and 1146 could fail. Failure would indicate either problems with the system or more likely an attempt to forge an authorization request. In a preferred embodiment, failure of any of these steps results in an error report being displayed on device 1003 and the discarding of the request.

At step 1148, a notification of a login request from the website domain with website id is sent to website authorization application 1114. At step 1149, the website authorization application generates a one-time use website URL for a single authorized session for the website id. At step 1150, the one-time use website URL is returned to API 1020.

Continuing with FIG. 11C, after step 1150, starting with step 1154, the one-time use website URL is concatenated to the login request document to form a login response document. At step 1156, the login response document is signed with the website private key and at step 1158 it is encrypted with the website public key.

At step 1160, API 1020 submits the login response document to authorization transaction server 1001. At step 1164, authorization transaction server 1001 stores the login response document with the existing transaction in the transaction database and, at step 1166, notifies native authorization application 1011. At step 1168, a success indicator is returned to website authorization application 1114.

At step 1170, native authorization application 1011 requests pending responses from the authorization transaction server for the website id. At step 1172, the authorization transaction server looks up any pending authorization responses for the website id and at step 1174 returns a pending response document.

At step 1176, native authorization application 1011 uses the website private key to decrypt the pending response document. At step 1178, the signature on the pending response document is validated with the website public key. At step 1180, the pending response document is evaluated for approval.

If approved in step 1180, then step 1182 is performed wherein native authorization application 1011 displays the one-time use website URL on device 1003. At step 1182, the one-time use website URL is clicked through which opens web browser 1012, and at step 1182, the web browser establishes a pre-authorized web session for website id on an “in-band” communication path between device 1003 and website server 1004.

If not approved in step 1180, then step 1184 is performed which displays an appropriate error message on device 1003.

It will be appreciated that a copy of all authorization transactions are kept in the transaction database by the authorization transaction server. These transactions could be decrypted, for example, in a legal situation where the parties involved were forced to provide their private key information.

In another embodiment, the native authorization application and the third-party authorization application keep local logs of incoming and outgoing authorization transactions which would provide a cryptographically strong record, better than a simple electronic receipt of the transaction.

In yet another embodiment, the native authorization application and the third party authorization application are enabled to send and receive electronic transaction receipts, signifying a completed and itemized purchase, for example.

It will be appreciated by those skilled in the art that changes could be made to the exemplary embodiments described above without departing from the broad inventive concept thereof. It is understood, therefore, that this invention is not limited to the particular embodiments disclosed, but it is intended to cover modifications within the spirit and scope as defined by the appended claims.

1. An authorization system for authorizing a transaction comprising:
a first computing device comprising a first processor and executing a first set of program instructions that generates an authorization request to authorize the transaction;
a second computing device, comprising a second processor and executing a second set of program instructions that generates an authorization response based on the authorization request and a public key;
a third computing device, in communications with the first computing device and the second computing device, comprising a third processor executing a third set of program instructions that:
communicates the authorization request and the public key from the first computing device to the second computing device; and,
communicates the authorization response from the second computing device to the first computing device.

2. The authorization system of claim 1 wherein the third set of program instructions further comprises:
receiving the authorization request from the first computing device;
accessing a public key from a PKI store based on the authorization request;
notifying the second computing device with the authorization request and the public key;
receiving an authorization response from the second computing device; and,
sending the authorization response to the first computing device.

3. The authorization system of claim 2 wherein the first set of program instructions further comprises:
sending PKI credentials to the third computing device;
receiving the public key from the third computing device based on the PKI credentials;
signing the authorization request with a private key;
encrypting the authorization request with the public key;
sending the authorization request to the third computing device;
receiving the authorization response from the third computing device;

4. The authorization system of claim 3 wherein the second set of program instructions comprises:
receiving the authorization request and the public key from the third computing device;
decrypting the authorization request based on the public key and the private key
sending the authorization response to the third computing device.

5. The authorization system of claim 1 wherein the third set of program instructions comprises:
implementing a PKI store for storing and retrieving public key credentials; and,
implementing a transaction database for storing and retrieving authorization transactions.

6. The authorization system of claim 5 wherein the third set of program instructions comprises:
receiving a user id from the first computing device;
determining if the user id is available in the PM store;
receiving a public key from the first computing device; and,
adding the public key to the PKI store if the user id is available.

7. The authorization system of claim 1 wherein the first set of program instructions comprises:
sending a user id to the third computing device;
creating an asymmetric key pair including a public key and a private key;
sending the public key to the third computing device; and,
encrypting the private key.

8. The authorization system of claim 1 wherein the third set of program instructions comprises:
implementing an API for authorizing transactions;
wherein at least one of the second computing device and the first computing device communicate to the third computing device through the API.

9. The authorization system of claim 1 wherein the third set of program instructions comprises:
implementing a PKI store for storing and retrieving public key credentials;
receiving a user id from the second computing device;
determining if the user id is available in the PKI store;
creating an asymmetric key pair including a public key and a private key;
storing the public key in the PKI store if the user id is available; and,
communicating the private key to the second computing device.

10. An authorization system for authorizing a transaction occurring between two entities over an in-band communication path comprising:
a first computing device comprising a first processor and executing a first set of program instructions that generates a request to authorize the transaction;
a second computing device, comprising a second processor and executing a second set of program instructions that generates an authorization response based on the request;
a third computing device, in communications with the first computing device and the second computing device over a set of out-of-band communication paths different than the in-band communication path;
wherein the third computing device comprises a third processor executing a third set of program instructions that:
communicates the request from the first computing device to the second computing device over the set of out-of-band communication paths; and,
communicates the authorization response from the second computing device to the first computing device over the set of out-of-band communication paths.

11. The system of claim 11 wherein the first computing device is selected from the group consisting of a website server and a credit card transaction server.

12. The system of claim 11 wherein the second computing device is a mobile device.

13. A method for authorizing a transaction between a set of devices communicating on a first network path, comprising the steps of:
operating a first authorization application by a first computing device;
operating a second authorization application by a second computing device;
operating an authorizing service application by a third computing device;
sending an authorization request from the first computing device to the third computing device;
retrieving a set of credentials for the authorization request;
encrypting the authorization request with the set of credentials;
sending the authorization request from the third computing device to the second computing device;
decrypting the authorization request with the set of credentials;
determining an authorization response based on the authorization request and the set of credentials;
sending the authorization response from the second computing device to the third computing device; and,
sending the authorization response from the third computing device to the first computing device.

14. The method of claim 13 wherein the retrieving the set of credentials further comprises:
providing a PKI store in the third computing device;
receiving a user id; and,
retrieving a public key from the PKI store based on the user id.

15. The method of claim 14 further comprising:
creating an asymmetric key pair including a public key and a private key; and,
storing the public key in the PKI store if the user id is available.

16. The method of claim 15 further comprising creating the asymmetric key pair with the first computing device and storing the private key in a memory of the first computing device.

17. The method of claim 15 further comprising creating the asymmetric key pair with the second computing device and storing the private key in a memory of the second computing device.

18. The method of claim 13 further comprising:
defining an API interface;
communicating between the third computing device and the first computing device through the API interface.

19. The method of claim 13 further comprising:
defining an API interface;
communicating between the third computing device and the second computing device through the API interface.

20. The method of claim 13 further comprising communicating between the first computing device, the second computing device and the third computing device on a second network path.

21. The method of claim 13 further comprising the steps:
including a website id and a website domain in the authorization request;
including a website address in the authorization response; and,
opening a web session from the first authorization application based on the authorization response.
